(19) United States
(12) Patent Application Publication
(10) Pub. No.: US 2009/0126963 A1
(43) Pub. Date: May 21, 2009

(54) Hand-held power tool

(75) Inventor: Helmut Burger, Moorenweis (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/974,164

(22) Filed: Oct. 10, 2007

(30) Foreign Application Priority Data
Oct. 12, 2006 (DE) 10 2006 035 341.2

(51) Int. Cl. B25F 5/00; B23B 45/02

(52) U.S. Cl. 173/217; 173/170

(57) ABSTRACT

A hand-held power tool includes an electric motor (19) located in the tool housing (11), at least one electrical switch (17) for operating the electric motor and having an actuation element (18) extendable through the opening (16) formed in the housing (11), and a spring-biased displaceable closing body arranged at the opening for at least partially closing the opening and controlled by the actuation element (18) of the at least one electrical switch (17).

### BACKGROUND OF THE INVENTION

1. Field of the Invention

The present invention relates to a hand-held power tool including a housing having an opening, an electric motor located in the housing, and at least one electrical switch for operating the electric motor and having an actuation element extendable through the opening, and in particular to such hand-held power tools as, e.g., drilling or percussion power tools or screw driving tool.

2. Description of the Prior Art

German Publication DE 102 27 782 A1 discloses a hand-held power tool having a device for a clockwise and counterclockwise change-over switching of an electric motor, which device has an actuation element that projects through a window formed in the housing of the hand-held power tool. On opposite sides of the actuation element, there are arranged air openings which selectively overlap air openings in the carbon brush holder of the electric motor in accordance with the position of the actuation element.

A drawback of the above-discussed power tool consists in that through the openings not only cooling air but also large particles which can adversely affect the service life of the motor, can penetrate.

German Utility Model DE 203 00 599 U1 discloses an electrical hand-held power tool in which means for adjusting the rotational direction is integrated as a slider on a switch pressure button of a switch for actuating the electric motor.

The drawback of such a slide switch consists in that the guide grooves of the slide guide can be contaminated with dust and particles, which would make the displacement of the switching slide difficult and, thereby, would make its actuation difficult.

An object of the invention is to provide a hand-held power tool in which the above-discussed drawbacks of the prior art tools are eliminated.

### SUMMARY OF THE INVENTION

This and other objects of the present invention, which will become apparent hereinafter, are achieved by providing in a hand-held power tool of the type discussed above, a displaceable closing body arranged at the opening for at least partially closing the opening and controlled by the actuation element of the at least one electrical switch, and spring means for biasing the closing body towards the opening.

The closing body prevents, on one hand, contamination of the displacement path of the actuation element and which would have made its displacement very difficult and, thus, non-actuatable and, on the other hand, prevents large particles from reaching the electric motor and damaging it.

Advantageously, the closing body closes at least 50% of the opening in both first position and second position of the actuation member.

Thus, only a very small gap in the opening remains open through which, however, no large particles can penetrate in the housing, which provides for a sufficiently free displacement of the actuation element.

It is advantageous when the closing body is pivotally supported on a housing part adjacent to the opening. Thereby, the closing body can, by pivoting, follow a switching movement of the actuation member.

Advantageously, the spring means comprises two bistable spring elements that apply a biasing force to respective end regions of the closing body, so that the closing body becomes pivoted as a yoke in two stable closing positions.

According to an advantageous embodiment of the present invention, the closing body has first and second closing sections arranged at an obtuse angle relative to each other and biased in direction of the opening by the respective spring elements. Thereby, in a simple manner, an automatic pivotal movement of the closing body upon adjustment of the actuation element is achieved.

By forming the spring elements as arms of an arc-shaped spring stirrup, a high closing force and resiliency are achieved without large technical expenses.

Advantageously, the closing body and the spring means are formed as a one-piece closing element.

Advantageously, the closing element has a support element for counter-support element provided on the first housing part and formed as an axle journal or an eyelet, so that the closing body can be pivotally supported on the housing part in a simple manner.

A good pivotal geometry is achieved when the support element and the counter support element define an axis extending transverse to a longitudinal axis of the opening.

The manufacturing can also be simplified when the closing element is formed of a plastic material and formed, e.g., as a plastic injection-molded part that can, thus be, cost-effectively produced.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partial view of a hand-held power tool according to the present invention with a switching member shown in cross-section in a first switching position;

FIG. 2 a partial view of the hand-held power tool shown in FIG. 1 with the switching member in the intermediate switching position;

FIG. 3 a partial view of the hand-held power tool shown in FIG. 1 with the switching member in the second switching position; and

FIG. 4 a cross-sectional view of the inventive hand-held power tool along line IV-IV in FIG. 2.

### DETAILED DESCRIPTION OF THE PREFERRED EMBODIMENT

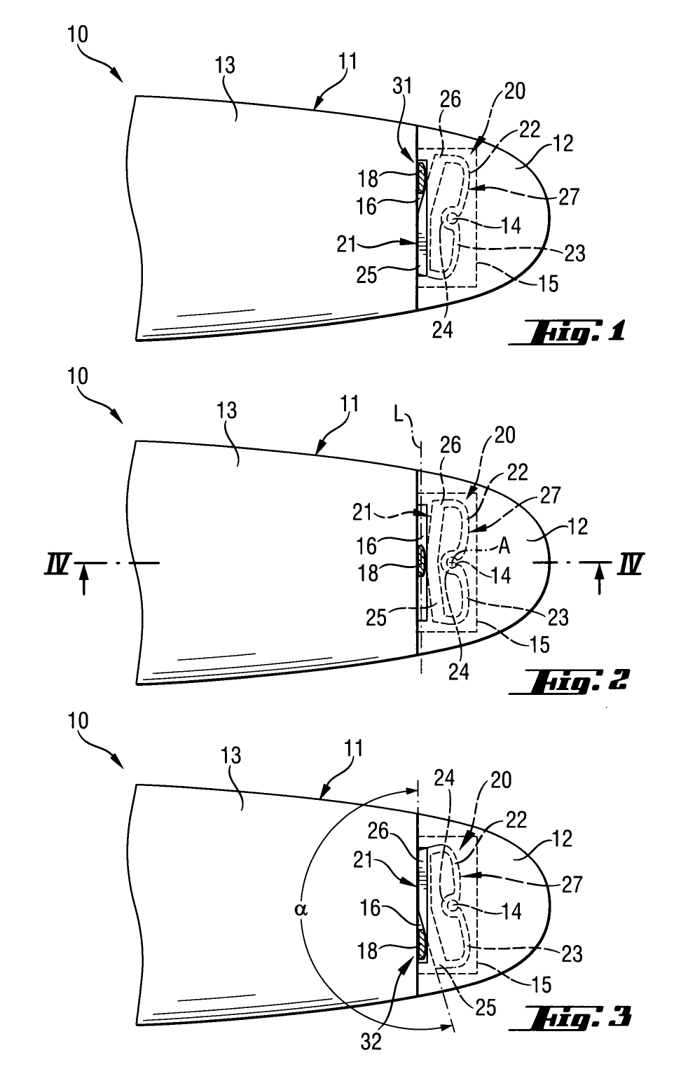

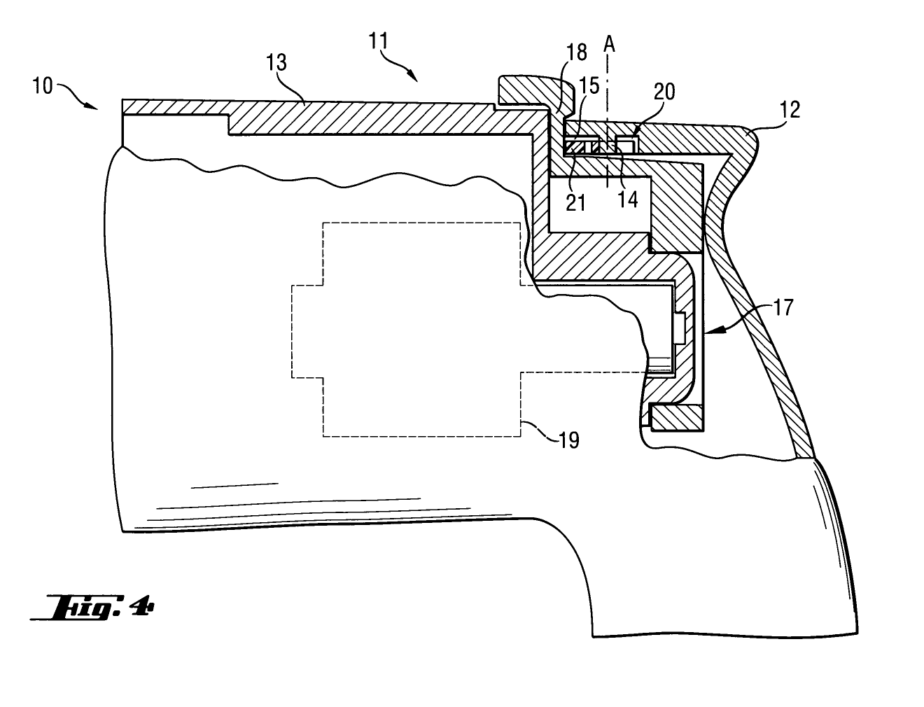

FIGS. 1-4 show a section of a hand-held power tool 10 according to the present invention and which includes a housing 11 formed of a first housing part 12 and a second housing part 13. In the first housing part 12, an electric motor 19 (see FIG. 4) for driving the power tool 10 is located. In addition to an on-off switch, not shown in the drawings, the hand-held power tool 10 has another switch 17 that is formed as clockwise/counterclockwise change-over switch and has an actuation element 18 extending from the housing 11 through a slot-shaped and elongate opening 16 so that it can be manually operated by a user. A closing element for the opening 16, which is generally designated with a reference numeral 20, is arranged in a recess 15 in the first housing part 12 directly against the opening 16. The closing element 20 is formed of a plastic material and has a closing body 21. The closing body 21 has a first closing section 25 and a second closing section 26 which are arranged relative to each other at an obtuse angle α greater than 180° and are connected with each other (see FIG. 3). The closing element 20 further has first and second bistable spring elements 22, 23. The spring elements 22, 23 are formed as arms of an arc-shaped spring stirrup 27 having in their center a support element 24 formed as an eyelet. The spring elements 22, 23 are connected, on one hand, with respective ends of the closing body 21 and, on the other hand, with the support element 24 of the closing element 20. The support element 24 pivotally supports the closing element 20 on a counter-support element 14 which is formed as an axle journal and is provided in the first housing part 12. Because a support axis A, which is defined by the support element 24 and the counter-support element 14, extends transverse to the axis L of the opening 16 (see FIG. 2), the closing element 20 can be pivoted with its closing body 16 in a position at least partially covering the opening 16. This pivotal movement of the closing element 20 takes place automatically dependent on a respective position of the actuation element 18, or is controlled by the actuation element 18. The closing body 21 serves, thus, as a switch yoke pivotable in two stable closing positions.

In FIG. 1, the actuation element 18 of the switch 17 is located in a first position 31 at an end of the opening 16 and which corresponds, e.g., to a clockwise position of the switch 17. The first closing section 25 and a portion of the second closing section 26 of the closing element 20 are located in the opening 16, closing at least 50% of the opening 16. The first closing section 25 is held in the position, in which it partially covers the opening 16, by the second spring element 23. A further portion of the opening 16 is filled with the actuation element 18. Thus, only a small slot remains open.

In FIG. 2, the actuation element 18 of the switch 17 is displaced from the first position 31 in a non-stable position intermediate position. In this intermediate position, the actuation element 18 is located in the opening 16 directly opposite the support element 24. The closing body 21 with both closing sections 25, 26 is pressed by the actuation element 18 from the position, in which, it closes the opening 16, out of the opening 16 against the biasing force of the spring elements 22, 23. This is because the closing body 21 contacts the actuation element 18 only with the vertexes of both closing sections 25, 26.

In FIG. 3, the actuation element 18 of the switch 17 is displaced further from the intermediate position in the second position 32 at the opposite end of the opening 16 which, e.g, corresponds to the clockwise position of the switch 17. The second closing section 26 and a portion of the first closing section 25 of the closing element 20 are pivoted by the first spring element 22 and are again located in the position covering the opening 16, closing again at least 50% of the opening 16. Another portion of the opening 16 is again closed by the actuation element 18, so that again only a small gap remains open.

Upon a new actuation of the actuation element 18 in the opposite direction from the second position 32 to the first position 31, the closing body 21 follows again because of action of the spring elements 22, 23, automatically the movement of the actuation element 18, occupying the position shown in FIG. 1.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising a housing (11) having an opening (16); an electric motor (19) located in the housing (11); at least one electrical switch (17) for operating the electric motor and having an actuation element (18) extendable through the opening (16); a displaceable closing body (21) arranged at the opening (11) for at least partially closing the opening and controlled by the actuation element (18) of the at least one electrical switch (17); and spring means for biasing the closing body (21) towards the opening (16).

2. A hand-held power tool according to claim 1, wherein the closing body (21) closes at least 50% of the opening (16) in both first position (31) and second position (32) of the actuation member (18).

3. A hand-held power tool according to claim 1, wherein the housing (11) has a first housing part (12), and the closing body (21) is pivotally supported in the first housing part (12) which is adjacent to the opening.

4. A hand-held power tool according to claim 1, wherein the spring means comprises bistable spring elements (22, 23) that apply a biasing force to respective end regions of the closing body (21).

5. A hand-held power tool according to claim 4, wherein the closing body (21) has first and second closing sections (25, 26) arranged at an obtuse angle relative to each other and biased in direction of the opening (16) by the respective spring elements (22, 23).

6. A hand-held power tool according to claim 4, wherein the two spring elements (22, 23) are formed by arms of an arc-shaped spring stirrup.

7. A hand-held power tool according to claim 5, wherein the closing body (21) and the spring elements (22, 23) are formed as one-piece closing element (20).

8. A hand-held power tool according to claim 7, wherein the closing element (20) has a support element (24) for a counter-support element (14) provided on the first housing part (12).

9. A hand-held power tool according to claim 8, wherein the support element (24) and the counter support element (14) define an axis (A) extending transverse to a longitudinal axis (L) of the opening (16).

10. A hand-held power tool according to claim 7, wherein the closing element (20) is formed of a plastic material.
